(19) United States
(12) Patent Application Publication
(10) Pub. No.: US 2023/0063448 A1
(43) Pub. Date: Mar. 2, 2023

(54) SYSTEM AND METHOD FOR MONITORING COMPROMISES IN DECISION MAKING

(71) Applicant: TOYOTA RESEARCH INSTITUTE, INC., Los Altos, CA (US)

(72) Inventors: Yin-Ying CHEN, San Jose, CA (US); Totte Harri HARINEN, San Francisco, CA (US); Scott CARTER, San Jose, CA (US); Rumen ILIEV, Milbrae, CA (US); Yue WENG, San Mateo, CA (US)

(73) Assignee: TOYOTA RESEARCH INSTITUTE, INC., Los Altos, CA (US)

(21) Appl. No.: 17/465,612

(22) Filed: Sep. 2, 2021

(51) Int. Cl. G06N 20/00; G06N 5/00; G06F 11/34; G06F 40/20; G06K 9/62

(52) U.S. Cl. CPC G06N 20/00; G06F 11/3438; G06F 40/20; G06K 9/6256; G06N 5/003

(57) ABSTRACT

A method for monitoring user decision making activity is described. The method includes logging a user decision and decision communications corresponding to the user decision. The method also includes identifying the user decision as a compromised user decision based on an emotional status of a user determined from the decision communications. The method further includes determining a subsequent emotional status of the user based on a subsequent user communication corresponding to the compromised user decision. The method also includes providing an advice recommendation to the user when a degraded emotional status is detected regarding the compromised decision.

### BACKGROUND

### Field

Certain aspects of the present disclosure generally relate to machine learning and, more particularly, to a system and method for monitoring compromises in decision making.

### Background

Individuals may lose confidence in decisions made with non-negligible compromises. In particular, the impacts caused by the non-negligible compromises of these decisions may cause the individual to experience regret. Over time, these the non-negligible compromises of these decisions may cause the individual to experience remorse. Conversely, some individuals perform certain decisions with too confident. The high confidence associated with these decisions may neglect possible negative future outcomes and/or concerns. Neglecting possible negative future outcomes and/or concerns may also cause the individual to experience regret and remorse over time.

Unfortunately, growing anxiety of individuals regarding decisions having non-negligible consequences may eventually lead to a worsened emotional status. A method for monitoring compromises in decision making of these individuals as well as a management strategy for ameliorating a worsened emotional status by a machine learning model trained on a set of past management strategies of the individuals are desired.

### SUMMARY

A method for monitoring user decision making activity is described. The method includes logging a user decision and decision communications corresponding to the user decision. The method also includes identifying the user decision as a compromised user decision based on an emotional status of a user determined from the decision communications. The method further includes determining a subsequent emotional status of the user based on a subsequent user communication corresponding to the compromised user decision. The method also includes providing an advice recommendation to the user when a degraded emotional status is detected regarding the compromised decision.

A non-transitory computer-readable medium having program code recorded thereon for monitoring user decision making activity is described. The program code is executed by a processor. The non-transitory computer-readable medium includes program code to log the user decision and decision communications corresponding to the user decision. The non-transitory computer-readable medium also includes program code to identify the user decision as a compromised user decision based on an emotional status of a user determined from the decision communications. The non-transitory computer-readable medium further includes program code to determine a subsequent emotional status of the user based on a subsequent user communication corresponding to the compromised user decision. The non-transitory computer-readable medium also includes program code to provide an advice recommendation to the user when a degraded emotional status is detected regarding the compromised decision.

A system for monitoring user decision making activity is described. The system includes a decision logging module to log the user decision and decision communications corresponding to the user decision. The system also includes a compromised decision identification module to identify the user decision as a compromised user decision based on an emotional status of a user determined from the decision communications. The system further includes an emotional status determination module to determine a subsequent emotional status of the user based on a subsequent user communication corresponding to the compromised user decision. The system also includes an advice/management model to provide an advice recommendation to the user when a degraded emotional status is detected regarding the compromised decision.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a compromised decision monitoring and recommendation system, in accordance with aspects of the present disclosure.

FIG. 2 is a block diagram illustrating an exemplary software architecture that may modularize artificial intelligence (AI) functions for a compromised decision monitoring and recommendation system, according to aspects of the present disclosure.

FIG. 3 is a diagram illustrating a hardware implementation for an compromised decision monitoring and recommendation system, according to aspects of the present disclosure.

FIG. 4 is a block diagram illustrating a compromised decision monitoring and recommendation system, in accordance with aspects of the present disclosure.

FIG. 5 is a flowchart illustrating a method for an monitoring user decision making activity, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Individuals may lose confidence in decisions made with non-negligible compromises. As described, user decisions made with non-negligible compromises are referred to as compromised user decisions. In particular, the impacts caused by the non-negligible compromises of these decisions may cause the individual to experience regret. Over time, these the non-negligible compromises of these decisions may cause the individual to experience remorse. Conversely, some individuals perform certain decisions with too confident. The high confidence associated with these decisions may neglect possible negative future outcomes and/or concerns. Neglecting possible negative future outcomes and/or concerns may also cause the individual to experience regret and remorse over time.

Unfortunately, growing anxiety of individuals regarding decisions having non-negligible consequences may eventually lead to a worsened emotional status. Some aspects of the present disclosure are directed to a method for monitoring compromises in decision making of individuals as well as a management strategy for ameliorating a worsened emotional status. Some aspects of the present disclosure ameliorate the worsened emotional status using a machine learning model trained on a set of past management strategies to provide an advice recommendation regarding compromised decisions.

In one aspect of the present disclosure, a compromised decision monitoring and recommendation system logs an initial decision-making process to analyze and understand a current state of events. Analyzing this initial decision-making process to understand the current state of events enables the compromised decision monitoring and recommendation system to show how past decisions led to a current state of events for addressing potential remorse. In some aspects, the compromised decision monitoring and recommendation system provides advice using a trained machine learning model to reduce the impact of future compromises associated with a compromised decision.

In other aspects of the present disclosure, the compromised decision monitoring and recommendation system encounters situations in which a user is too confident in a decision. In these aspects of the present disclosure, the compromised decision monitoring and recommendation system logs an initial decision process and concerns in the decision-making process. Subsequently, the compromised decision monitoring and recommendation system analyzes and understands a current state of events to determine whether any initial concerns have grown. According to this process, the compromised decision monitoring and recommendation system can increase awareness of the growing concerns and suggest appropriate management techniques to avoid possible regret in the future.

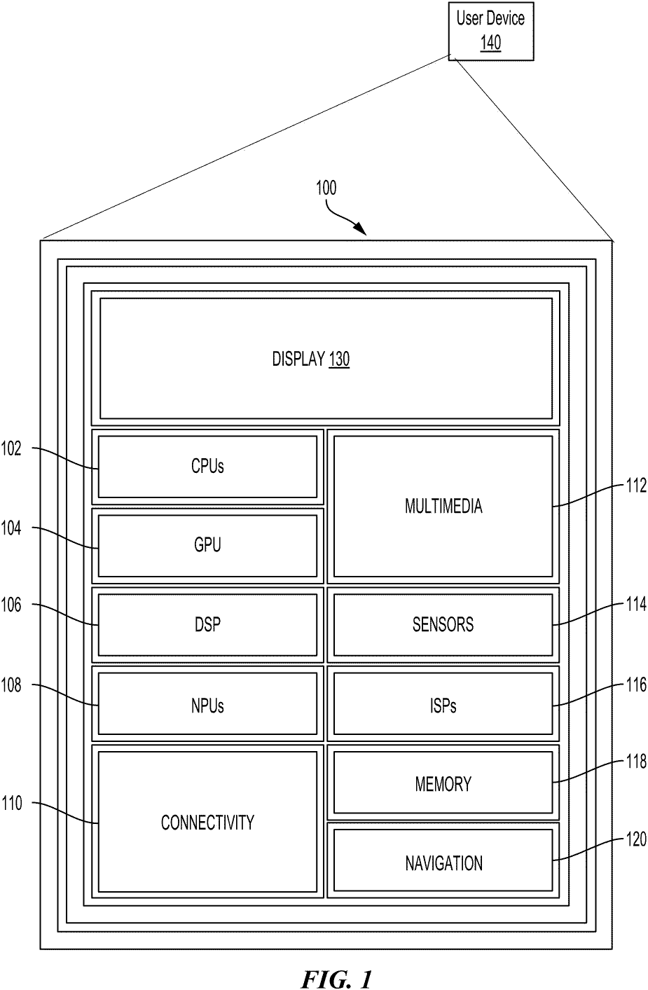

FIG. 1 illustrates an example implementation of the aforementioned system and method for a compromised decision monitoring and advice recommendation system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risk Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 of the user device 140 may include code to log a user decision and a decision communication corresponding to the user decision. The instructions loaded into a processor (e.g., CPU 102) may also include code to determine an emotional status of the user based on the decision communication to determine whether the user decision is a compromised user decision. The instructions loaded into a processor (e.g., CPU 102) may also include code to determine a subsequent emotional status of the user based on a subsequent captured user communication corresponding to the compromised user decision. The instructions loaded into a processor (e.g., CPU 102) may also include code to provide a management strategy to the user when a worsened emotional status is detected.

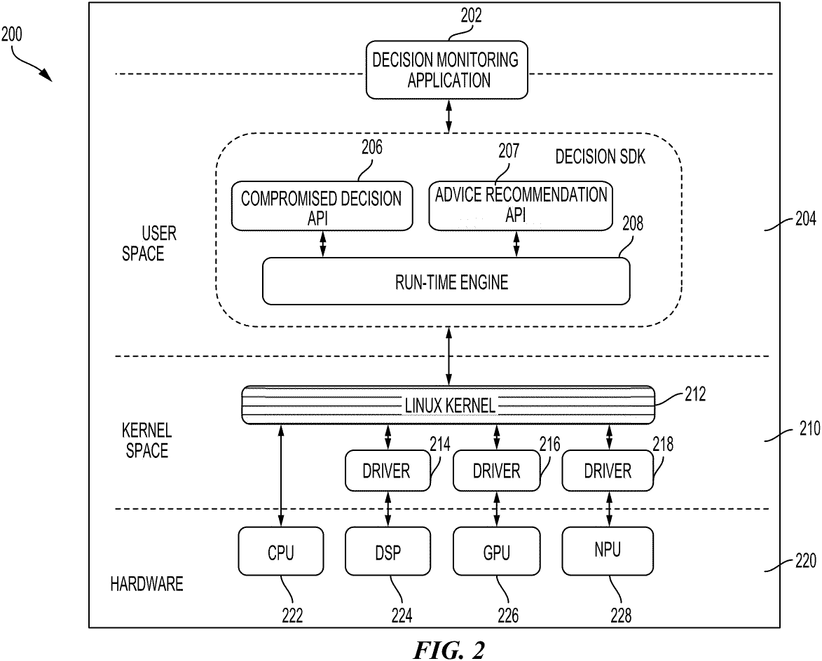

FIG. 2 is a block diagram illustrating a software architecture 200 that may modularize artificial intelligence (AI) functions for a compromised decision monitoring and advice recommendation system, according to aspects of the present disclosure. Using the architecture, a decision monitoring application 202 may be designed such that it may cause various processing blocks of an SOC 220 (for example a CPU 222, a DSP 224, a GPU 226, and/or an NPU 228) to perform supporting computations during run-time operation of the decision monitoring application 202. FIG. 2 describes the software architecture 200 for a compromised decision monitoring and advice recommendation, it should be recognized that the compromised decision monitoring and advice recommendation system is not limited to decisions involving compromises. According to aspects of the present disclosure, the compromised decision monitoring and advice recommendation functionality is applicable to any type of decision or user activity.

The decision monitoring application 202 may be configured to call functions defined in a user space 204 that may, for example, provide for user activity and decision monitoring services. The decision monitoring application 202 may make a request for compiled program code associated with a library defined in a compromised decision application programming interface (API) 206. The compromised decision API 206 is configured to log a compromised user decision and decision communications corresponding to the compromised user decision. The instructions loaded into a processor (e.g., CPU 102) may also include code to determine an emotional status of the user based on the decision communication. In response, compiled code of an advice recommendation API 207 is configure to determine a subsequent emotional status of the user based on a subsequent captured user communication corresponding to the compromised user decision. In addition, the advice recommendation API 207 is configure to provide an advice recommendation to the user when a worsened emotional status is detected regarding the compromised decision.

A run-time engine 208, which may be compiled code of a run-time framework, may be further accessible to the decision monitoring application 202. The decision monitoring application 202 may cause the run-time engine 208, for example, to take actions for providing advice recommendations in response to compromised user decision. In response to detection of a compromised user decision, the run-time engine 208 may in turn send a signal to an operating system 210, such as a Linux Kernel 212, running on the SOC 220. FIG. 2 illustrates the Linux Kernel 212 as software architecture for compromised decision monitoring and advice recommendation. It should be recognized, however, that aspects of the present disclosure are not limited to this exemplary software architecture. For example, other kernels may provide the software architecture to support compromised decision monitoring and advice recommendation functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

Individuals may lose confidence in decisions made with non-negligible compromises. As described, user decisions made with non-negligible compromises are referred to as compromised user decisions. In particular, the impacts caused by the non-negligible compromises of these decisions may cause the individual to experience regret. Over time, these the non-negligible compromises of these decisions may cause the individual to experience remorse. Conversely, some individuals perform certain decisions with too confident. The high confidence associated with these decisions may neglect possible negative future outcomes and/or concerns. Neglecting possible negative future outcomes and/or concerns may also cause the individual to experience regret and remorse over time.

Unfortunately, growing anxiety of individuals regarding decisions having non-negligible consequences (e.g., compromised user decisions) may eventually lead to a worsened emotional status. A method for monitoring compromises in decision making of these individuals as well as an advice recommendation (e.g., a management strategy) for ameliorating a worsened emotional status are desired. Some aspects of the present disclosure are directed to a method for monitoring compromises in decision making of individuals as well as a management strategy for ameliorating a worsened emotional status. Some aspects of the present disclosure ameliorate the worsened emotional status using a machine learning model trained on a set of past management strategies to provide an advice recommendation regarding compromised decisions.

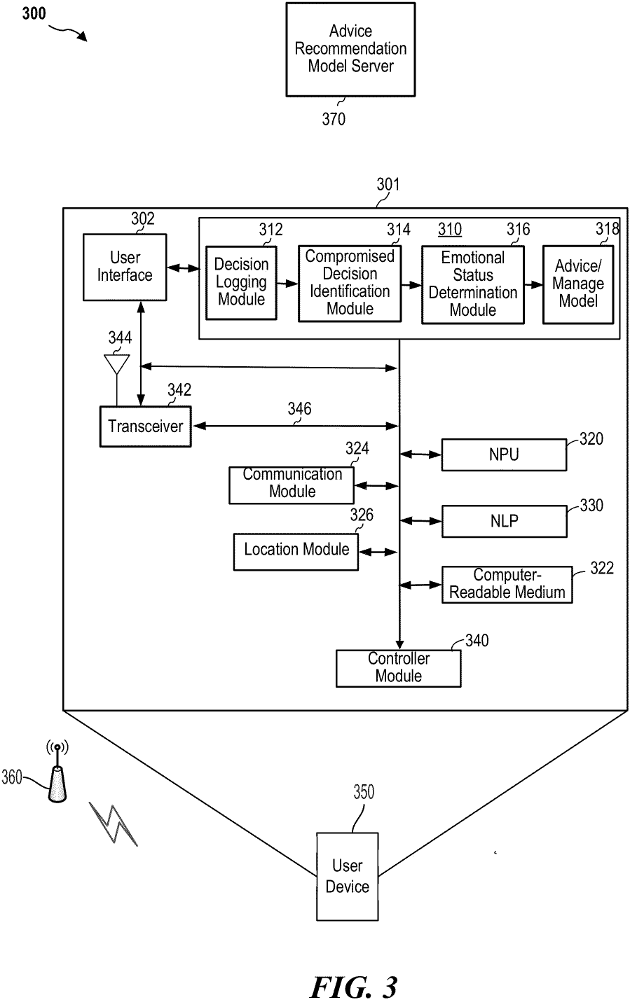

FIG. 3 is a diagram illustrating a hardware implementation for a user monitoring and advice recommendation system 300, according to aspects of the present disclosure. The user monitoring and advice recommendation system 300 may be configured to log a compromised user decision and decision communications corresponding to the compromised user decision. The user monitoring and advice recommendation system 300 is also configured to determine an emotional status of the user based on the decision communication. In response, the user monitoring and advice recommendation system 300 is configure to determine a subsequent emotional status of the user based on a subsequent captured user communication corresponding to the compromised user decision. In addition, the user monitoring and advice recommendation system 300 is configure to provide an advice recommendation to the user when a worsened emotional status is detected.

The user monitoring and advice recommendation system 300 includes a user monitoring system 301 and an advice recommendation model server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The advice recommendation model server 370 may connect to the user device 350 for providing advice recommendations. For example, the advice recommendation model server 370 may recommend appropriate advice, such as reminding a user that past, compromised user decisions were not as detrimental as remembered or that a new similar decision should be made more carefully in the future. The advice may be predetermined and correlated to certain types of user statuses and/or concerns. For example, the advice is also generated based on the statuses and/or concerns of other users and the strategies the other users used to successfully manage their statuses and/or concerns. Alternatively, the advice is generated based on the past statuses and/or concerns of the user and the strategies the user used to successfully manage the user’s statuses and/or concerns.

The user monitoring system 301 may be implemented with an interconnected architecture, represented generally by an interconnect 346. The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neutral network processor (NPU) 320, a computer-readable medium 322, a communication module 324, a location module 326, a natural language processor (NLP) 330, and a controller module 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the NLP 330, and the controller module 340. The transceiver 342 is coupled to an antenna 344. The transceiver 342 communicates with various other devices over a transmission medium. For example, the transceiver 342 may receive commands via transmissions from a user or a connected vehicle. In this example, the transceiver 342 may receive/transmit information for the user activity module 310 to/from connected devices within the vicinity of the user device 350.

The user monitoring system 301 includes the NPU 320 coupled to the computer-readable medium 322. The NPU 320 performs processing, including the execution of software stored on the computer-readable medium 322 to provide a neural network model for user monitoring and advice recommendation functionality according to the present disclosure. The software, when executed by the NPU 320, causes the user monitoring system 301 to perform the various functions described for user monitoring and advice recommendation through the user device 350, or any of the modules (e.g., 310, 324, 326, 330, and/or 340). The computer-readable medium 322 may also be used for storing data that is manipulated by the NLP 330 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the autonomous vehicle 350 and/or the location module 326 compliant with the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the NLP 330 to receive and analyze language from a data log of user communications to determine the user’s emotional status. For example, the user’s emotional status may indicate regret or confidence regarding a user decision. In some aspects of the present disclosure, the data log may use natural language processing of the NLP 330 to extract terms from communications regarding compromised user decisions, such as terms revealing that the user is feeling some regret about a user decision (e.g., a compromised user decision). For example, the is user concerned that too much money was spent and that the user may have compromised on the user’s budget to make the compromised user decision.

In aspects of the present disclosure, the NLP 330 is used if the communications are conducted in plain text. The user monitoring system 301, however, may receive and analyze the data log to determine the user’s concerns around a decision, such as compromises, risk, and costs. In these aspects of the present disclosure, the communications are a sequence of interaction logs (e.g., iterative searching process, selected filters, questionnaires). These communications may not be text but can be useful data to help determine a user emotional status (e.g., they are satisfied or not) using predictive analytics. These aspects of the present disclosure analyze non-language communications (e.g. those mentioned above) using machine learning models to determine a user emotional status.

The user activity module 310 may be in communication with the user interface 302, the NPU 320, the computer-readable medium 322, the communication module 324, the location module 326, the NLP 330, the controller module 340, and the transceiver 342. In one configuration, the user activity module 310 monitors communications from the user interface 302. The user interface 302 may monitor user communications to and from the communication module 324. According to aspects of the present disclosure, the NLP 330 may use natural language processing to extract terms from communications regarding compromised user decisions, such as terms revealing that the user is feeling some regret about a user decision (e.g., a compromised user decision).

As shown in FIG. 3, the user activity module 310 includes a decision logging module 312, a compromised decision identification module 314, an emotional status determination module 316, and an advice/management model 318. The decision logging module 312, the compromised decision identification module 314, the emotional status determination module 316, and the advice/management model 318 may be components of a same or different artificial neural network, such as a deep convolutional neural network (CNN). The user activity module 310 is not limited to a CNN. The user activity module 310 monitors and analyzes user communications received from the user interface 302.

This configuration of the user activity module 310 includes the decision logging module 312 for logging a user decision and a decision communication corresponding to the user decision through the user device 350. The user activity module 310 also includes the compromised decision identification module 314 for identifying the user decision as a compromised user decision based on an emotional status of the user determined from the decision communications. The user activity module 310 also includes the emotional status determination module 316 to determine a subsequent emotional status of the user based on a subsequent captured user communication corresponding to a compromised user decision. The user activity module 310 further includes advice/management model 318 to provide an advice recommendation to the user when a worsened emotional status is detected regarding the compromised decision.

In some aspects of the present disclosure, the advice/management model 318 suggests an intervention tailored to a particular user’s demographic information, decision type (e.g., personal, financial, social, etc. from the decision logging module 312), compromises logged or detected (e.g., from the compromised decision identification module 314) and an emotional status trajectory over time (e.g., from the emotional status determination module 316). After deploying the intervention, the advice recommendation system 300 continues to monitor the user’s emotional status to determine an effectiveness of the intervention. In addition, the intervention itself may also include questionnaires designed to elicit self-reported ratings of the usefulness of the intervention. In some aspects of the present disclosure, data from both the emotional status determination module 316 as well as the noted self-reporting measures are used as training data to tune the advice/management model 318. In some aspects of the present disclosure, the advice/management model 318 may be implemented and/or work in conjunction with the the advice recommendation model server 370.

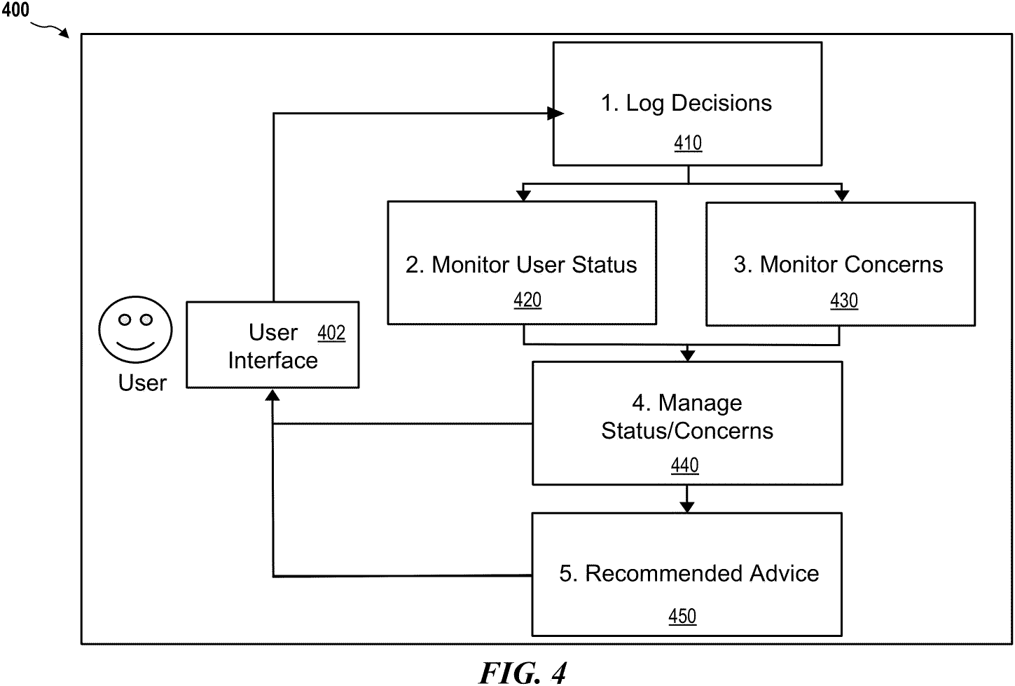

To further improve the quality of interventions recommended by the advice/management model 318, training data can be anonymized and pooled across users, in accordance with aspects of the present disclosure. For example, interventions recommended by the advice/management model 318 include a targeted audio-based and/or text-based dialog system that coaches a user through positive aspects of a priori decision; a graphic interactive user interface (UI) that allows users to explore the inputs and rationales that led to a past decision; a more straightforward step-based animation that explains (e.g., using images, text, and audio clips from a pre-specified repository) each aspect of the prior decision process; or an actionable plan to remedy inconvenience from compromises, for example, as shown in FIG. 4.

FIG. 4 is a block diagram illustrating a compromised decision monitoring and recommendation system, in accordance with aspects of the present disclosure. In some aspects of the present disclosure, a compromised decision monitoring and recommendation system 400 logs data regarding decisions that a user makes, determines user status and user concerns based on the logged data, track statuses and/or concerns over time and how the user remembers the past decision, and recommends decision-making strategies to manage statuses and/or concerns. In this configuration, the compromised decision monitoring and recommendation system 400 includes a user interface 402, a logging component 410, a user status component 420, a user concern component 430, a management component 440, and a recommendation component 450.

In this aspect of the present disclosure, the logging component 410 may log the decisions that a user makes and the contexts surrounding the decisions to generate a data log. For example, the contexts may include scenarios, environments, user concerns, user compromises, user confidence and affects, and other information relating to the decision. The user status component 420 may receive and analyze the data log to determine the user’s emotional status, such as regret and confidence. For example, the data log may use natural language processing (e.g., the NLP 330) to extract terms from communications from the decision, in which the terms reveal that the user is feeling some regret about the decision. While the user status component 420 is performing analysis of the data log, the user concern component 430 may receive and analyze the data log to determine the user’s concerns around the decision, such as compromises, risk, and costs. For example, the data log may use the NLP 330 to extract terms from communications regarding a compromised user decisions. In this example, compromised user decisions may involve terms that reveal the user is feeling regret about the decisions because there is a concern that too much money may have been spent and that the user may have compromised on the user’s budget to make the decision.

In some aspects of the present disclosure, the management component 440 may receive the results from the user status component 420 and the user concern component 430 to track user status and user concerns over time. The management component 440 may compare an initial user status and user concerns to a subsequent user status and user concerns relating to the same, compromised user decision. The management component 440 may generate an output corresponding to whether the user’s status has worsened and/or concerns have grown. Based on an output the management component 440, the recommendation component 450 may recommend appropriate advice. For example, the appropriate advice may include reminding the user that past decisions were not as detrimental as remembered or that a new similar decision should be made more carefully in the future.

According to aspects of the present disclosure, the recommendation component 450 is implemented using a trained machine learning model. For example, the recommendation component 450 is implemented using a machine learning model trained on a set of past management strategies of the user. In some aspects of the present disclosure, the recommendation component 450 is implemented using the advice/management model 318 of the user monitoring and advice recommendation system 300 of FIG. 3.

The recommendation component 450 may connect to the user interface 402 to provide an advice recommendation for the user. For example, the recommendation component 450 may recommend appropriate advice, such as reminding the user that a past, compromised user decision was not as detrimental as remembered. Conversely, the recommendation component 450 may recommend that a new, similar decision should be made more carefully in the future. In some aspects of the present disclosure, the machine learning model of the recommendation component 450 is trained to provide advice that is predetermined and correlated to certain types of user statuses and/or concerns. For example, the machine learning model of the recommendation component 450 is trained to generate advice based on the statuses and/or concerns of other users and the strategies the other users used to successfully manage their statuses and/or concerns.

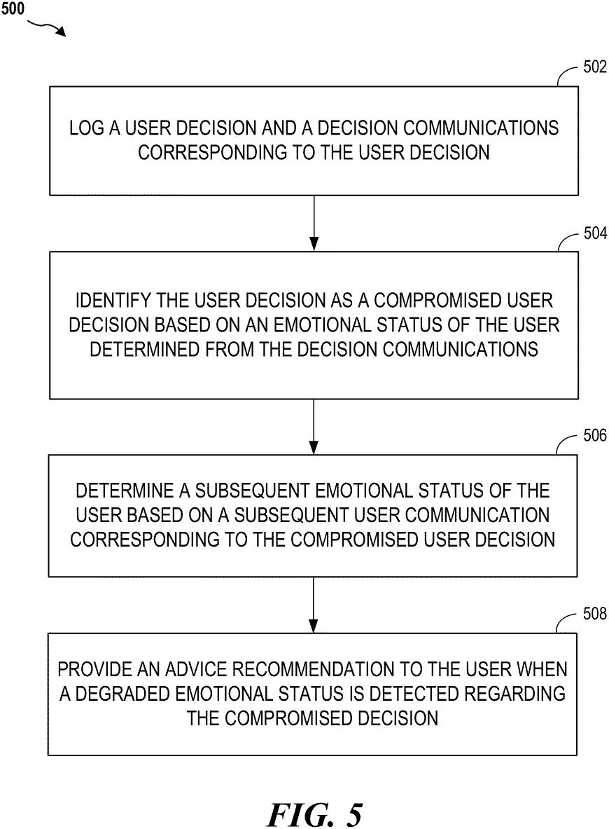

Alternatively, the machine learning model of the recommendation component 450 is trained to generate advice based on the past statuses and/or concerns of the user and the strategies the user applied to successfully manage the user’s statuses and/or concerns. The compromised decision monitoring and recommendation system 400 may engage in a process, for example, as shown in FIG. 5.

FIG. 5 is a flowchart illustrating a method for monitoring user decision making activity, according to aspects of the present disclosure. A method 500 of FIG. 6 begins at block 602, in which a user decision and decision communications corresponding to the user decision are logged. For example, as described in FIG. 3, this configuration of the user activity module 310 includes the decision logging module 312 for logging a user decision and a decision communication corresponding to the user decision through the user device 350. As shown in FIG. 4, the logging component 410 may log the decisions that a user makes and the contexts surrounding the decisions to generate a data log. For example, the contexts may include scenarios, environments, user concerns, user compromises, user confidence and affects, and other information relating to the decision.

Referring again to FIG. 5, at block 504, the user decision is identified as a compromised user decision based on an emotional status of the user determined from the decision communications. For example, as shown in FIG. 3, the user activity module 310 also includes the compromised decision identification module 314 for identifying the user decision as a compromised user decision based on an emotional status of the user determined from the decision communications. As shown in FIG. 4, The user status component 420 may receive and analyze the data log to determine the user’s emotional status, such as regret and confidence.

For example, the compromised decision identification module 314 may use natural language processing (e.g., the NLP 330) to extract terms from communications from the decision, in which the terms reveal that the user is feeling some regret about the decision. While the user status component 420 is performing analysis of the data log, the user concern component 430 may receive and analyze the data log to determine the user’s concerns around the decision, such as compromises, risk, and costs. For example, the data log may use the NLP 330 to extract terms from communications regarding a compromised user decisions. In this example, compromised user decisions may involve terms that reveal the user is feeling regret about the decisions because there is a concern that too much money may have been spent and that the user may have compromised on the user’s budget to make the decision.

At block 506, a subsequent emotional status of the user is determined based on a subsequent user communication corresponding to the compromised user decision. For example, as shown in FIG. 3, the user activity module 310 also includes the emotional status determination module 316 to determine a subsequent emotional status of the user based on a subsequent captured user communication corresponding to a compromised user decision. As shown in FIG. 4, the management component 440 may receive the results from the user status component 420 and the user concern component 430 to track user status and user concerns over time. The management component 440 may compare an initial user status and user concerns to a subsequent user status and user concerns relating to the same, compromised user decision. The management component 440 may generate an output corresponding to whether the user’s status has worsened and/or concerns have grown.

At block 508, an advice recommendation is provided to the user when a degraded emotional status is detected regarding the compromised decision. For example, as shown in FIG. 3, The user activity module 310 further includes advice/management model 318 to provide an advice recommendation to the user when a worsened emotional status is detected regarding the compromised decision. As shown in FIG. 4, the recommendation component 450 is implemented using a trained machine learning model. To further improve the quality of interventions recommended by the recommendation component 450, training data can be anonymized and pooled across users, in accordance with aspects of the present disclosure. For example, interventions recommended by the recommendation component 450 include a targeted audio-based and/or text-based dialog system that coaches a user through positive aspects of a priori decision; a graphic interactive user interface (UI) that allows users to explore the inputs and rationales that led to a past decision; a more straightforward step-based animation that explains (e.g., using images, text, and audio clips from a pre-specified repository) each aspect of the prior decision process; or an actionable plan to remedy inconvenience from compromises.

For example, the recommendation component 450 is implemented using a machine learning model trained on a set of past management strategies of the user, such as the advice/management model 318 of the user activity module 310 shown in FIG. 3. In some aspects of the present disclosure, after deploying an intervention, the user activity module 310 continues to monitor the user’s emotional status to determine an effectiveness of the intervention. In addition, the intervention itself may also include questionnaires designed to elicit self-reported ratings of the usefulness of the intervention. In some aspects of the present disclosure, data from both the emotional status determination module 316 as well as the noted self-reporting measures are used as training data to tune the advice/management model 318.

The method 500 also includes detecting the degraded emotional status of the user regarding the compromised user decision. The method 500 further includes generating, by a machine learning model trained on a set of user management strategies, a management strategy for ameliorating the degraded emotional status of the user. The method 500 also includes detecting over confidence of the user regarding a subsequent user decision according to subsequent communications associated with the subsequent user decision. The method 500 further includes providing a subsequent advice recommendation regarding negative consequences associates with neglecting of previous similar decisions. The method 500 also includes determining management strategies applied to reduce an impact of compromised user decisions. The method 500 further includes training an advice recommendation machine learning model according to the determined management strategies applied to reduce the impact of compromised user decisions.

Aspects of the present disclosure are directed to a compromised decision monitoring and recommendation system. In some aspects of the present disclosure, compromised decision monitoring and recommendation system logs an initial decision-making process to analyze and understand a current state of events. The compromised decision monitoring and recommendation system is configured to process an initial decision-making process to analyze and understand the current state of events. This process enables the compromised decision monitoring and recommendation system to show how past decisions led to a current state of events for address potential remorse. In some aspects, the compromised decision monitoring and recommendation system provides advice using a trained machine learning model to reduce the impact of future compromises associated with a compromised decision.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for monitoring user decision making activity, comprising:
logging a user decision and decision communications corresponding to the user decision;
identifying the user decision as a compromised user decision based on an emotional status of a user determined from the decision communications;
determining a subsequent emotional status of the user based on a subsequent user communication corresponding to the compromised user decision; and
providing an advice recommendation to the user when a degraded emotional status is detected regarding the compromised decision.

2. The method of claim 1, in which determining the subsequent emotional status of the user comprises:
logging the subsequent communication of the user corresponding to the compromised user decision;
analyzing, using a natural language processor, terms of the subsequent communication to determine the subsequent emotional status of the user; and
analyzing, using a machine learning model, non-language communications to determine the subsequent emotional status of the user.

3. The method of claim 1, further comprising comparing the emotional status to the subsequent emotional status to determine whether the degraded emotional status of the user is detected.

4. The method of claim 1, in which providing the advice recommendation comprises:
detecting the degraded emotional status of the user regarding the compromised user decision; and
generating, by a machine learning model trained on a set of user management strategies, a management strategy for ameliorating the degraded emotional status of the user.

5. The method of claim 1, further comprising concurrently monitoring a status and monitoring concerns of the user regarding the compromised user decision.

6. The method of claim 1, further comprising:
detecting over confidence of the user regarding a subsequent user decision according to subsequent communications associated with the subsequent user decision; and
providing a subsequent advice recommendation regarding negative consequences associates with neglecting of previous similar decisions.

7. The method of claim 1, further comprising:
determining management strategies applied to reduce the impact of compromised user decisions; and
training an advice recommendation machine learning model according to the determined management strategies applied to reduce the impact of compromised user decisions.

8. The method of claim 1, in which logging the user decision comprises compiling contexts surrounding the user decision to generate a data log, in which the contexts comprise scenarios, environments, concerns of the user, compromises of the user, confidence and affects of the user, and/or information relating to the user decision.

9. A non-transitory computer-readable medium having program code recorded thereon for monitoring user decision making activity, the program code being executed by a processor and comprising:
program code to log the user decision and decision communications corresponding to the user decision;
program code to identify the user decision as a compromised user decision based on an emotional status of a user determined from the decision communications;
program code to determine a subsequent emotional status of the user based on a subsequent user communication corresponding to the compromised user decision; and
program code to provide an advice recommendation to the user when a degraded emotional status is detected regarding the compromised decision.

10. The non-transitory computer-readable medium of claim 9, in which the program code to determine the subsequent emotional status of the user comprises:
program code to log the subsequent communication of the user corresponding to the compromised user decision;
program code to analyze, using a natural language processor, terms of the subsequent communication to determine the subsequent emotional status of the user; and
program code to analyze, using a machine learning model, non-language communications to determine the subsequent emotional status of the user.

11. The non-transitory computer-readable medium of claim 9, further comprising program code to compare the emotional status to the subsequent emotional status to determine whether the degraded emotional status of the user is detected.

12. The non-transitory computer-readable medium of claim 9, in which the program code to provide the advice recommendation comprises:
program code to detect the degraded emotional status of the user regarding the compromised user decision; and
program code to generate, by a machine learning model trained on a set of user management strategies, a management strategy to ameliorate the degraded emotional status of the user.

13. The non-transitory computer-readable medium of claim 9, further comprising program code to concurrently monitor a status and monitor concerns of the user regarding the compromised user decision.

14. The non-transitory computer-readable medium of claim 9, further comprising:
program code to detect over confidence of the user regarding a subsequent user decision according to subsequent communications associated with the subsequent user decision; and
program code to provide a subsequent advice recommendation regarding negative consequences associates with neglecting of previous similar decisions.

15. The non-transitory computer-readable medium of claim 9, further comprising:
program code to determine management strategies applied to reduce the impact of compromised user decisions; and
program code to train an advice recommendation machine learning model according to the determined management strategies applied to reduce the impact of compromised user decisions.

16. The non-transitory computer-readable medium of claim 9, in which the program code to log the user decision comprises program code to compile contexts surrounding the user decision to generate a data log, in which the contexts comprise scenarios, environments, concerns of the user, compromises of the user, confidence and effects on the user, and/or information relating to the user decision.

17. A system for monitoring user decision making activity, the system comprising:
a decision logging module to log the user decision and decision communications corresponding to the user decision;
a compromised decision identification module to identify the user decision as a compromised user decision based on an emotional status of a user determined from the decision communications;
an emotional status determination module to determine a subsequent emotional status of the user based on a subsequent user communication corresponding to the compromised user decision; and
an advice/management model to provide an advice recommendation to the user when a degraded emotional status is detected regarding the compromised decision.

18. The system of claim 17, in which the advice/manage model is further to detect the degraded emotional status of the user regarding the compromised user decision, and to generate, by a machine learning model trained on a set of user management strategies, a management strategy to ameliorate the degraded emotional status of the user.

19. The non-transitory computer-readable medium of claim 17, in which the emotional status determination module is further to concurrently monitor a status and monitor concerns of the user regarding the compromised user decision.

20. The system of claim 17, in which the decision logging module is further to compile contexts surrounding the user decision to generate a data log, in which the contexts comprise scenarios, environments, concerns of the user, compromises of the user, confidence and effects on the user, and/or information relating to the user decision.
